(19) United States
(12) Patent Application Publication
(10) Pub. No.: US 2024/0370595 A1
(43) Pub. Date: Nov. 7, 2024

(54) MACHINE LEARNING ALGORITHM-BASED INTERIOR DESIGN PLAN

(71) Applicant: STRUKSHUR INC., Santa Rosa, CA (US)

(72) Inventor: Louis A Vierra, Sonoma, CA (US)

(21) Appl. No.: 18/653,659

(22) Filed: May 2, 2024

Related U.S. Application Data
(60) Provisional application No. 63/499,884, filed on May 3, 2023.

(51) Int. Cl. G06F 30/13; G06F 30/12; G06F 30/27

(52) U.S. Cl. CPC G06F 30/13; G06F 30/12; G06F 30/27

(57) ABSTRACT

Described is a system for generating an interior design plan by identifying a prompt of a user indicating an intent of the user for a physical space, receiving dimensional information regarding the physical space, and applying a collection of data corresponding to the prompt and dimensional information to a first machine learning model to generate an interior design plan for the physical space. The system then causes display of a three-dimensional virtual space with virtual objects or patterns based on the interior design plan, where the dimensions of the three-dimensional virtual space match the dimensional information of the physical space.

### CROSS-REFERENCE TO RELATED APPLICATION

This patent application claims the benefit of U.S. Provisional Patent Application No. 63/499,884, filed May 3, 2023, entitled “MACHINE LEARNING ALGORITHM-BASED INTERIOR DESIGN PLAN”, which is incorporated by reference herein in its entirety.

### TECHNICAL FIELD

The present disclosure relates generally to machine learning algorithms, and more specifically to machine learning algorithms for generating interior design plans.

### BACKGROUND

As the popularity of Artificial Intelligence (AI) grows, companies use machine learning models in various ways, which is transforming how we process, analyze, and interact with visual data. The use of AI in image processing involves training algorithms, particularly deep learning models like Convolutional Neural Networks (CNNs), to perform tasks that range from low-level image manipulation to high-level understanding and generation of visual content. Some prominent applications of AI in images include image classification, object detection, image segmentation, facial recognition, and style transfer.

### BRIEF DESCRIPTION OF THE SEVERAL VIEWS OF THE DRAWINGS

In the drawings, which are not necessarily drawn to scale, like numerals may describe similar components in different views. To identify the discussion of any particular element or act more easily, the most significant digit or digits in a reference number refer to the figure number in which that element is first introduced. Some non-limiting examples are illustrated in the figures of the accompanying drawings in which:

FIG. 1 illustrates an example method for using a machine learning model to generate an interior design plan, according to some examples.

FIG. 2 illustrates prompts and other input from a user that can be used by a machine learning model to generate an interior design plan, according to some examples.

FIG. 3 illustrates additional inputs and outputs to a machine learning model trained to generate an interior design plan, according to some examples.

FIG. 4 illustrates a machine learning model that generates a 3D model for a physical space enabling a user to take a virtual tour, according to some examples.

FIG. 5 depicts an illustrative computer system architecture that may be used in accordance with one or more illustrative aspects described herein.

FIG. 6 illustrates training and use of a machine-learning program, according to some examples.

FIG. 7 illustrates a machine-learning pipeline, according to some examples.

FIG. 8 illustrates the use of pixel data to enhance the machine learning model, according to some examples.

### DETAILED DESCRIPTION

Traditional systems have helped families remodel homes, build new homes, and provided landscaping services in several different stages, including planning, design, and construction. However, there are many pitfalls to these traditional methods.

Home remodeling can be a daunting and overwhelming task, especially when it comes to choosing finishes and materials for a new home or remodeling. The process can be time-consuming, confusing, and expensive, requiring multiple visits to showrooms and consultations with architects and designers.

Moreover, contractors often rely on their experience and industry standards to provide cost and time estimates. These estimates can be imprecise, leading to budget overruns and project delays. Additionally, clients may struggle to visualize the end result, making it difficult for them to make informed decisions about design choices and materials.

Traditional construction projects involve multiple stakeholders like architects, engineers, and subcontractors. Communication between these parties can be slow, inaccurate, and become outdated, leading to misunderstandings and errors. A lack of standardized systems for information sharing in real-time can exacerbate these issues, resulting in costly rework and extended timelines.

Contractors often use static blueprints and plans, which can be difficult to update and share with relevant parties. This can also lead to outdated information, mismanagement of resources, and inefficient construction processes. Inflexible planning tools may also hinder the ability to adapt to unforeseen challenges or changes in client preferences during the project.

Construction quality is also heavily dependent on the skills of individual workers. This can lead to variability in the quality of work, which in turn may necessitate costly repairs and adjustments. Insufficient worker training, a misunderstanding or mismatching of professional skills, and a lack of standardized quality control processes can further exacerbate these issues.

Traditional construction methods can be resource-intensive and generate a significant amount of waste, leading to negative environmental consequences. Inefficient use of materials and energy, as well as a lack of focus on sustainable construction practices, contribute to this problem and increase the industry's overall environmental footprint.

Example systems described herein address the pitfalls of traditional systems by leveraging machine learning, advanced data processing, and enhanced communication capabilities. The Artificial Intelligence (AI) platforms described herein create customized designs from scratch based on images, videos, user prompt, availability of materials and contractors, and/or the like. The AI platform selects interior and exterior finishes while utilizing an interface that communicates directly to manufacturers to create the specified finishes.

The AI system is equipped with a vast database of interior and exterior home designs, styles, and finishes that can be used as training data or reference data to create a unique design for the user. The AI system allows the user to input preferences for the design, including a desired layout or a machine suggested layout, color palette, materials, finishes, and/or the like. The AI system applies the user information to a machine learning model to generate a design that meets the user's specifications. After the design is created, the user has the option to expand or modify the design through user feedback.

The AI system is also designed to interface directly with manufacturers to create the specified finishes for the user's design. Such specific finishes include walling, flooring, roofing, framing and rough structures, interior finishes, and/or the like that can be viewed by a user in a three dimensional virtual space. The AI system uses machine learning algorithms to analyze the user's preferences/constraints/designs and determines the best materials, finishes, and colors for a particular space. Once an order is generated by the AI system, the AI system then transmits this information directly to one or more manufacturer servers that initiates production and/or delivery of the finishes according to the user's specifications.

The AI system automatically communicates with contractor servers, supplier servers, and other stakeholder servers, facilitating better and automated communication and coordination. The AI system can retrieve contractor availability information, location coverage, and calendar for scheduling. This addresses the issue of slow communication and the lack of standardized systems for information sharing, reducing misunderstandings and errors. Such automation of sharing information helps to detect potential conflicts in design or scheduling.

The AI system described herein solves many of the problems associated with traditional home building and remodels. The AI system eliminates the need for multiple visits to showrooms and consultations with design professionals. Instead the AI system leverages the entire database of design models that has been created over an extended period of time. The AI system is designed to be easy to use and accessible to a wide range of users, regardless of their level of expertise in interior design.

Furthermore, by applying a machine learning model to generate an interior design plan based on the user's prompt and dimensional information, the AI system allows for more accurate cost and time estimates. The three-dimensional virtual space enables clients to visualize the end result, making it easier for them to make informed decisions about design choices and materials. The machine learning algorithms can analyze historical data from similar projects to provide more accurate cost and time estimates, helping contractors make informed decisions and avoid budget overruns.

The AI system also generates an interior design plan that incorporates project management scheduling, delivery dates for suppliers, and contractors' working schedules. This allows for real-time updates, ensuring that the available information is always current and resources are managed efficiently. The AI system also accommodates user-requested revisions and updates, allowing for greater adaptability to unforeseen challenges and changes in client preferences.

The AI system applies machine learning algorithms to develop dynamic construction plans that can be easily updated and shared in real-time. This allows contractors to optimize resource allocation and construction processes, reducing waste and improving efficiency. By utilizing machine learning models, the AI system analyzes construction data, such as images and sensor readings, to identify potential quality issues early on. This can help contractors address problems before they escalate, minimizing the need for costly repairs and adjustments.

The AI system optimizes material usage and construction processes, reducing waste and minimizing the environmental impact of construction projects. The AI system also applies machine learning models to help contractors select more sustainable materials and construction techniques.

In summary, the AI system addresses one or more pitfalls of traditional construction methods by improving cost and time estimates, enhancing communication and coordination among stakeholders, providing dynamic planning and updates, ensuring better quality control, and reducing the environmental impact. These improvements can lead to more efficient construction processes, cost savings, and increased customer satisfaction.

When the effects in this disclosure are considered in aggregate, one or more of the methodologies described herein may improve known systems, providing additional functionality (such as, but not limited to, the functionality mentioned above), making them easier, faster, or more intuitive to operate, and/or obviating a need for certain efforts or resources that otherwise would be involved in the construction, remodeling, or landscaping process. Computing resources used by one or more machines, databases, or networks may thus be more efficiently utilized or even reduced.

Computer software, hardware, and networks may be utilized in a variety of different system environments, including standalone, networked, remote-access (aka, remote desktop), virtualized, and/or cloud-based environments, among others.

### Interior Design Plan Generated by Machine Learning Model

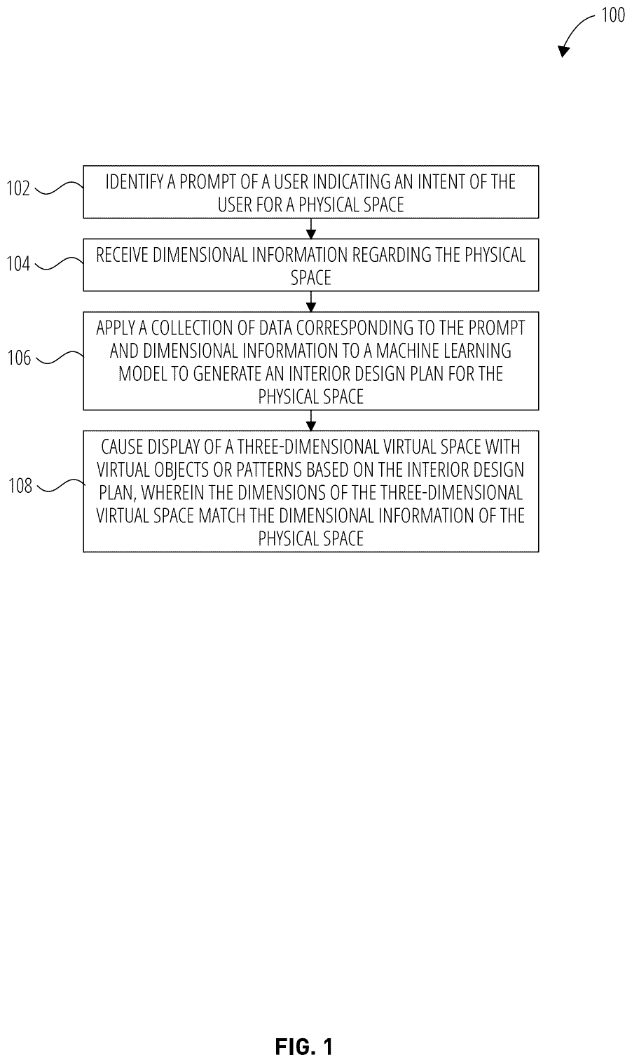

FIG. 1 illustrates an example method 100 for using a machine learning model to generate an interior design plan, according to some examples. Although the example method 100 depicts a particular sequence of operations, the sequence may be altered without departing from the scope of the present disclosure. For example, some of the operations depicted may be performed in parallel or in a different sequence that does not materially affect the function of the method 100. In other examples, different components of an example device or system that implements the method 100 may perform functions at substantially the same time or in a specific sequence.

FIG. 1 is described as being performed by certain processes, such as a particular machine learning model or computer vision model, but the processes described herein can be performed by one or more other or the same machine learning models, computer vision models, or a combination thereof.

The examples described herein provide details on certain user prompts, preferences, and intent for a physical space, but features identified or processes applying one of the above can be applied to others. For example, an example of a user prompt described herein can be inferred by the AI system as a user intent or preference.

At operation 102, the AI system identifies a prompt of a user indicating an intent of the user for a physical space. The AI system detects a user's input or request, which shows the user's intent or purpose for a particular physical space. The input could be in the form of text, voice, or other means. The prompt includes details about the desired functionality, style, or appearance of the space.

At operation 104, the AI system receives dimensional information regarding the physical space. The AI system obtains information about the size and shape of the physical space for which the interior design plan is being generated. This information could include measurements like length, width, and height, or other relevant details that help define the space.

The user provides spatial constraints such that the machine learning model creates an interior design plan that makes the best use of available space, such as multi-functional furniture or clever storage options. Addressing spatial limitations can help maximize the functionality and comfort of a room, even in challenging layouts or small areas.

At operation 106, the AI system applies a collection of data corresponding to the prompt and dimensional information to a machine learning model to generate an interior design plan for the physical space.

In this step, the collected data from the user's prompt and the dimensional information of the physical space are inputted into a machine learning model. The model processes this data and generates an interior design plan that is tailored to the specific needs and preferences expressed in the prompt and the dimensions of the space.

At operation 108, the AI system causes display of a three-dimensional virtual space with virtual objects or patterns based on the interior design plan. The dimensions of the three-dimensional virtual space match the dimensional information of the physical space.

The generated interior design plan is used to create a 3D virtual representation of the physical space, such as the 3D representation of the interior design plan 216. This virtual space will include virtual objects, furniture, or patterns that correspond to the elements of the interior design plan. The dimensions of the virtual space are designed to match the dimensions of the actual physical space, allowing the user to visualize how the final design will look and feel in real life.

Prompts and Other Input from a User

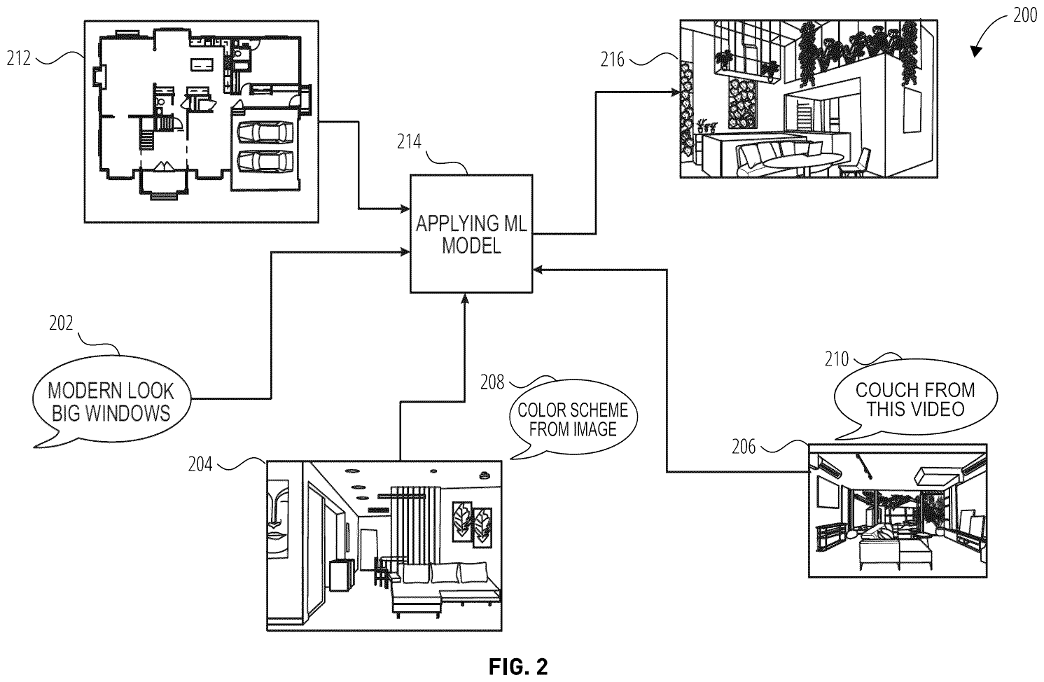

FIG. 2 illustrates prompts and other input from a user that can be used by a machine learning model to generate an interior design plan 200, according to some examples. The AI system receives a prompt directly from the user in the form of voice commands or text input, creates a prompt from user data (such as contextual information), or refines a received prompt. The user verbally describes their preferences or type them into a text box, which the AI system would then use to create the prompt. In the example of FIG. 2, the user states a preference in prompt 202 of “modern look big windows.”

The AI system can identify a textual prompt from the verbal input by employing speech recognition or speech-to-text conversion. The AI system records or receives a recording of verbal speech by the user. The AI system identifies the prompt by extracting a textual prompt from the recording of the verbal speech. In some examples, the user's spoken command is captured by a microphone or other audio input device.

The AI system preprocesses the raw audio signal to remove noise, normalize volume levels, and convert it into a suitable format, where a machine learning model is trained to recognize and transcribe human speech. In some cases, the AI system analyzes the audio input, identifies phonemes (distinct units of sound), and maps them to words and phrases based on the language model it has been trained on.

The AI system performs post-processing of the transcribed text to correct errors, handle homophones, or apply language-specific rules, such as removal of capitalization or punctuation. The final transcribed text is then extracted and used as the textual prompt for the subsequent steps in the interior design generation process.

In some examples, the prompt includes a request for the AI system to generate an interior design plan without specifying detailed preferences. Such a prompt can include some preferences, such as a particular style, theme, functionality, furniture, color, and/or the like.

In some examples, the prompt includes a user's specific preferences for various aspects of the interior design, such as a desired layout, color scheme, materials used, and surface finishes. The user could provide these preferences through a combination of text, voice, or selecting options from a menu or interface.

The user inputs a user's style preferences to influence the overall aesthetic and atmosphere of a space. For example, the user can input furniture shapes, color schemes, and decorative elements that create a cohesive visual theme.

The prompt can include a user's functionality requirements. The intended function of a space affects the layout, furniture choices, and other design elements to ensure the space meets the user's practical needs. For example, a home office may require a desk and ergonomic chair, while a playroom may need durable, child-friendly furniture and storage solutions.

The prompt can include a color scheme that sets the mood and tone of a space and can be based on the user's personal preferences, current trends, or psychological effects of specific colors. The machine learning model can then select a color palette that can harmonize various design elements and create a visually appealing environment.

The prompt can include material preferences, where these different materials can impact the appearance, durability, and maintenance requirements of a space. For example, wood can provide a warm, natural look, while metal or glass can evoke a sleek, modern vibe.

The prompt can include furniture preferences, such that the machine learning model generates an interior design plan that reflects the user's taste, lifestyle, and the overall theme of the space. Furniture styles can range from ornate, traditional pieces to minimalist, contemporary designs, and play a significant role in defining the look and feel of a room.

The prompt can include budget limitations which can influence the choice of materials, furniture, and finishes used in a design plan. The machine learning model can generate a well-designed plan that can be achieved at various price points by balancing higher-end items with more affordable options or by focusing on cost-effective solutions that still align with the user's preferences.

The prompt can include images or videos, such as images uploaded by the user, videos retrieved from third party websites, and/or the like. The machine learning model can apply these images or videos as visual references to help identify a user's design preferences and provide inspiration for the machine learning algorithm to generate a personalized interior design plan. In the example of FIG. 2, the user inputs image 204 and image 206, while also including a prompt 208 indicating that for image 204, the user desires the “color scheme from the image” and another prompt 210 indicating that for image 206, the user desires the “couch from this video.” The user could provide URLs or upload files to be used as a basis for generating the prompt.

In some examples, the prompt of a user can be inferred based on user past behavior, preferences, or other available data, without the user explicitly providing a prompt. The system may analyze the user's browsing history, previously saved designs, or interactions with similar design tools to determine their preferences and create a prompt accordingly.

A prompt of a user can be inferred for an interior design plan without the user explicitly providing a prompt through a variety of different third party databases. The AI system can analyze the user's social media profiles to identify their design preferences based on the images, posts, or boards they have liked, shared, or saved. This information can help the system understand the user's preferred styles, color schemes, and design elements.

The AI system can analyze the user's online shopping history, including browsing patterns and purchase history on e-commerce platforms or interior design websites. This analysis can reveal the user's preferences for furniture, materials, or accessories, and inform the design plan.

The AI system can use geographical information to infer the user's design preferences based on local architecture, interior design trends, and cultural influences. For example, users from a specific region may prefer a particular design style, color palette, or type of furniture due to regional preferences and cultural norms.

The AI system can analyze demographic information, such as age, profession, and lifestyle, to infer the user's design preferences. For instance, young professionals might prefer modern, minimalistic designs, while families with children might prioritize functionality and safety.

The AI system can gather input from the user's friends or family members, who might have insights into the user's design preferences. This information can be collected through social media interactions or direct communication with the user's connections.

The AI system can analyze data from other users with similar profiles or preferences to make recommendations for the user. By identifying users with similar design preferences, the system can generate a design plan that is likely to align with the user's unspoken desires.

The AI system can input images or videos of a real-world physical space into a machine learning model to identify characteristics of the physical space and use that information as an indication of the user's preferences or desires to ultimately generate an interior design plan. These images or videos can showcase specific design elements, color schemes, or overall styles that the user admires or wishes to incorporate into their space. Such image or video input can be used to supplement a prompt provided by the user, or be used to infer a user's desire and generate a prompt for the user.

The AI system employs a machine learning model, such as a Convolutional Neural Network (CNN), to extract features and patterns from the images or videos. These features can include colors, textures, shapes, furniture styles, and other design elements present in the physical space.

The AI system analyzes the extracted features to identify the design characteristics and preferences of the user. The AI system can use clustering of similar features, detecting of patterns, or comparing of the features to a pre-defined database of design styles or elements. The AI system can then formulate a set of user preferences that reflect the user's desired design elements, style, and overall aesthetic. Such formulation can occur within a machine learning model and/or such formulation of user preferences can be inputted into a machine learning model with other inputs and constraints (such as budget, spatial limitations, etc.) to generate the interior design plan.

Users can provide spatial constraints for interior design in various formats, depending on the available resources and the level of detail needed for the design process. A user can provide a floor plan, such as floor plan 212. The user-provided floor plan is a 2D representation of a space, providing a top-down view of the room or building layout. Floor plans typically include dimensions, the location of doors, windows, walls, and any built-in structures such as cabinets or staircases. Users can provide a digital or scanned image of a floor plan or hand-drawn sketches with measurements.

In some examples, the user provides LiDAR (Light Detection and Ranging) data which is a remote sensing technology that uses lasers to measure distances and generate detailed, accurate 3D representations of a space. Users can provide LiDAR data captured by specialized devices or mobile applications, which can then be used to create a 3D model of the space with accurate dimensions and spatial relationships.

In some examples, the user provides a 3D model, which is a digital representation of a physical space, offering a more detailed and immersive view of the space. Some users may also provide photogrammetry data, which uses a series of 2D images to reconstruct a 3D model of the space. Such 3D models can include the 3D models disclosed in U.S. Pat. No. 11,532,141 and U.S. Pat. Publ. No. 2022/0012658, whereby the disclosures are incorporated herein by reference in their entirety.

In some examples, the users provide basic room dimensions, such as length, width, and height, along with the location of doors, windows, and any built-in structures.

In some examples, the user provides photographs of the space from various angles, which can be helpful for understanding the existing layout, furniture, and design elements. Photographs can be useful for giving the AI system a sense of the space and its constraints.

Such photographs or videos of the real-world space can be used by the machine learning model to perform object detection (further described herein) and factor in existing features, such as flooring, furniture, and color scheme, to generate an interior design plan that meets a customer's expected budget.

In some examples, the user provides a video walkthrough of the physical space which allows the AI system to observe the space from multiple perspectives and gain a better understanding of the layout and design elements. Video data can also be used in combination with other formats, such as photographs or floor plans, to provide a more comprehensive view of the space and its constraints.

The AI system can apply the photographs or video walkthroughs of a physical step to generate an interior design by employing a machine learning model, such as a Convolutional Neural Network (CNN), to extract features and patterns from the photographs or video frames. These features can include colors, textures, shapes, furniture styles, and other design elements present in the physical space. The AI system can assess the extracted features to deduct design preferences and desires and/or any existing design elements that should be preserved or modified.

By analyzing multiple photographs or video frames taken from different angles, the AI system can estimate the dimensions, layout, and spatial relationships within the physical space, which can be used to generate constraints for the new interior design plan.

There are a variety of different physical spaces for which an interior design plan can be generated, catering to different functions and purposes. In some examples, the physical spaces include residential spaces, such as a living room, a bedroom, a kitchen, a dining room, a bathroom, a home office, a nursery or children's room, a home theater or entertainment room, a mudroom or entryway, a garage or workshop, and/or the like. In some examples, the physical spaces include commercial spaces, such as office spaces, retail stores, restaurants, cafes, bars, hotels, motels, bed and breakfasts, conference rooms, meeting spaces, co-working spaces, lobbies, reception areas, showrooms, galleries, spas, salons, fitness centers, and/or the like.

In some examples, the physical spaces include institutional spaces, such as schools or universities, hospitals or healthcare facilities, museums or exhibition halls, libraries, places of worship, government buildings or public spaces, sports facilities or gyms, and/or the like. In some examples, the physical spaces include outdoor spaces, such as patios or decks, balconies or terraces, gardens or courtyards, pool areas or outdoor kitchens, and/or the like. In some examples, the physical spaces include specialized spaces, such as adaptive or accessible spaces for people with disabilities, sustainable or eco-friendly designs, tiny homes or small living spaces, industrial or warehouse conversions, historical or heritage buildings, and/or the like.

As shown in the example of FIG. 2, various inputs, such as a prompt 202, an image 204, a floor plan 212, and/or the like can be applied to a machine learning model 214 to generate an interior design plan 216. The interior design plan includes a 3D model with modern looking big windows as noted by prompt 202, a similar color scheme from image 204, and a similar couch from image 206. The prompt provides an indication of a user's intent for the physical space.

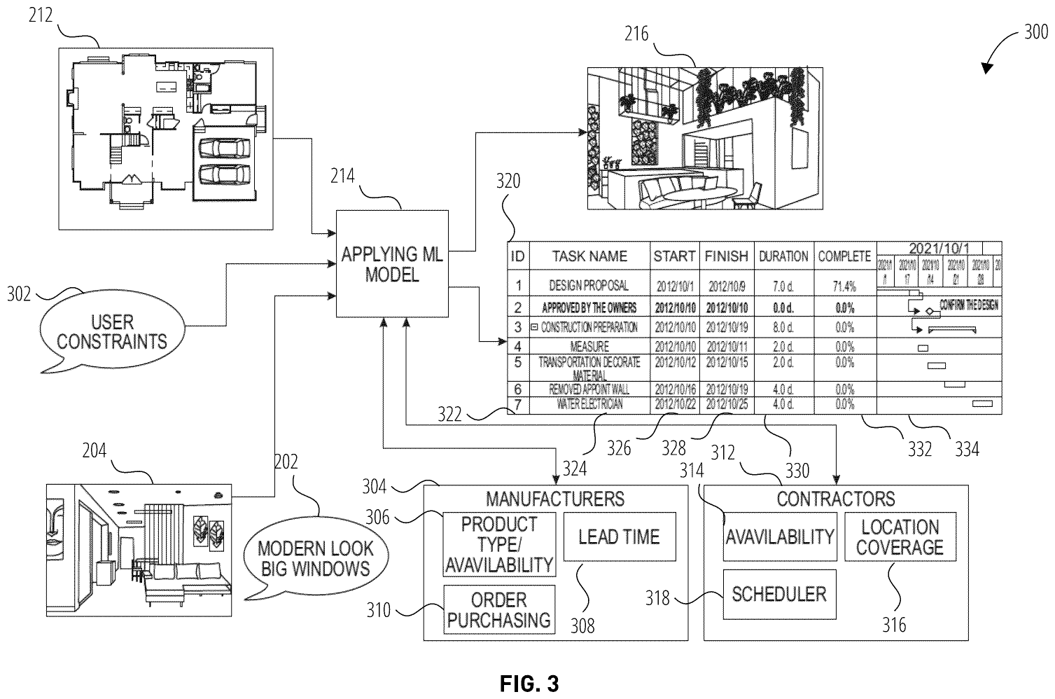

FIG. 3 illustrates additional inputs and outputs to a machine learning model trained to generate an interior design plan 300, according to some examples. In some cases, the user provides specific user constraints 302. There are numerous user preferences for a physical space that the AI system can apply to the machine learning model to consider when generating an interior design plan. The AI system can identify a user preference related to a design style, such as modern, minimalist, industrial, Scandinavian, traditional, rustic, or eclectic. The prompt can provide an indication of a user's preference for particular color schemes or individual colors that they want to be incorporated into their space.

In some examples, the users may prefer specific materials or finishes for their furniture, flooring, walls, and other design elements, such as wood, metal, glass, natural fibers, polished concrete, or marble. Users might have preferences for certain types or styles of furniture, such as mid-century modern, modular, vintage, or custom-made pieces. Users could prefer specific types of textiles or fabrics for upholstery, curtains, cushions, or rugs, such as cotton, linen, silk, leather, or synthetic materials.

Users may have preferences for the type of lighting, such as ambient, task, or accent lighting, as well as the style of light fixtures, including pendant lights, floor lamps, or recessed lighting. Users may have preferences in electrical wiring or plumbing, such as placement of outlets, toilets, or showers.

In some cases, users might have preferences for the arrangement of furniture and design elements within their space, such as an open floor plan, separate zones for different activities, or specific positioning of furniture for optimal flow and functionality. Users may prefer specific storage solutions, such as built-in cabinets, shelves, or wardrobes, to help them stay organized and make the most of their space.

Users might have preferences for the type of artwork, wall decor, or decorative accessories they want to include in their space, such as paintings, photographs, sculptures, or accent pieces. Users may have specific requirements for how their space should function, such as needing a designated workspace, a play area for children, or a comfortable seating area for entertaining guests.

In some cases, users might require their space to be designed with accessibility in mind, such as wheelchair access, wide doorways, or accommodations for visual or hearing impairments. Users may prefer their space to be designed with environmentally friendly materials, energy-efficient lighting, or other sustainable design elements.

The user inputs their preferences for the design, including desired layout, color palette, materials, finishes, and/or the like by inputting their design preferences manually via one or more prompts on a user interface and/or the AI-based system automatically identifies design elements, such as applying factors described herein including the user's past preferences or other available data. Such user constraints 302 can be inputted into the machine learning model 214 for the machine learning model to consider when generating the interior design plan.

The AI system uses of information from merchants and contractors to further generate a more accurate interior design plan. Information from manufacturer servers 304 and from contractor servers 312 can be passed to and from the AI system.

Information passed to and from manufacturer systems can be used by a machine learning model to generate an interior design plan in several ways. Manufacturers maintain extensive product catalogs that include detailed information about furniture, lighting, accessories, and other design elements. The AI system can input this information to the machine learning model during training, evaluating, and performing inferences by the model, allowing the model to suggest specific products from the manufacturer that align with the user's preferences and the generated design plan.

Manufacturer systems can provide real-time data on product types, availability and pricing 306, which can be valuable input for the machine learning model. By considering this data, the model can generate design plans that not only meet user preferences but also adhere to budget constraints and feature currently available products.

The machine learning model can use this information to generate design plans that include personalized products tailored to the user's preferences.

Manufacturers may specialize in certain design styles or aesthetics. By incorporating this specialty information, the machine learning model can generate design plans that feature products from specific manufacturers aligned with the user's desired style.

Certain design elements or materials may be subject to manufacturing constraints or limitations. The machine learning model can take this information into account when generating design plans, ensuring that the suggested products can be feasibly produced and delivered to the user.

Manufacturer systems can provide information on production lead times 308 and delivery schedules. This information can be used by the machine learning model to prioritize products that can be delivered within the user's desired time frame, and identify the critical path in the project management schedule. The machine learning model can optimize when certain products should be ordered or services should be performed to meet a particular deadline based on these lead times and delivery schedules.

Manufacturers may collect customer feedback, reviews, or ratings on their products. This data can be used by the machine learning model as an additional factor when selecting products to include in the design plan, prioritizing items with higher customer satisfaction.

Information passed to and from contractor systems can be also used by a machine learning model to generate an interior design plan in several ways. Different contractors may specialize in specific aspects of interior design or construction, such as flooring, painting, or custom cabinetry. By incorporating this specialty information into the machine learning model, the generated design plan can take advantage of the expertise of the available contractors and tailor the design accordingly.

Contractors have their schedules and availability 314 for new projects. By considering this information, the machine learning model can generate a design plan that aligns with the user's desired timeline and the availability of the appropriate contractors.

Contractors are typically familiar with local building codes, zoning regulations, and other requirements that may impact the interior design plan, and can vary depending on the geographic location. The machine learning model can use this information to ensure that the generated design plan complies with relevant regulations and avoids potential issues during the construction or renovation process.

Contractors can provide cost estimates for various design elements, materials, and labor. By incorporating this information into the machine learning model, the generated design plan can take into account the user's budget and prioritize elements that are both desirable and cost-effective.

Contractors may have valuable insights and suggestions based on their experience working on similar projects. The machine learning model can use this feedback to refine the design plan and incorporate elements that have proven successful or appealing in previous projects.

Contractors may only be able to service certain geographical locations. The machine learning model can use the location coverage 316 of these contractors to identify contractors that are available for the special needs required by the interior design plan.

Integrating manufacturer and contractor systems with the machine learning model can facilitate seamless communication between the user, the model, manufacturers, and contractors. This can help ensure that the design plan evolves and adapts to any changes or constraints that may arise during the construction or renovation process.

In some examples, the AI system searches a database of home designs, styles, finishes, and/or the like to create a custom design that fits a user's geographic location. Such information is inputted into the machine learning model to generate the interior design plan.

The machine learning model is trained to generate interior design plans based on data corresponding to physical dimensions of physical spaces and design constraints for the physical spaces. To train a machine learning model for generating interior design plans, the AI system gathers a dataset of diverse examples of interior designs. This data can include images, videos, textual descriptions, or 3D models of various interior spaces. The data encompasses a wide range of design styles, color schemes, furniture choices, and spatial configurations to ensure the model can generate diverse and relevant design plans.

The collected data is preprocessed to ensure it is suitable for training the machine learning model. The AI system resizes images, converts video frames into images, or extracts relevant features from textual descriptions. For 3D models, the AI system convert the models into a standard format or generating 2D images from different viewpoints.

Then, the AI system extracts relevant features from the preprocessed data that represent essential design elements, such as color schemes, furniture styles, or layout patterns. These features can be used as input for the machine learning model, helping the model understand and identify the key characteristics of different interior designs.

Once the data has been preprocessed and the features have been extracted, the machine learning model is trained on the data. During this phase, the model learns to recognize patterns and relationships between various design elements and user preferences. The model's performance is evaluated on a separate validation set to avoid overfitting and ensure that it generalizes well to new, unseen data.

A machine learning model can generate various features of an interior design plan 320 based on a variety of inputs, such as user intent, physical space dimensions, constraints, product information from merchants, and contractor information. The model can generate an optimal layout for the space that accommodates user preferences and functional requirements while considering the dimensions and constraints of the physical space.

Based on user preferences and intent, the model can suggest a harmonious color palette for walls, flooring, furniture, and accessories, taking into account current trends and complementary color combinations. The model can recommend specific furniture pieces from merchants' catalogs that align with the user's style preferences, budget, and space constraints.

The model can suggest appropriate lighting solutions, including the placement and type of fixtures, to achieve the desired ambiance and functionality. The model can recommend suitable materials for flooring, walls, and countertops based on user preferences, budget, and maintenance requirements.

The model can identify efficient storage options, such as built-in cabinets, shelves, or closets that maximize the use of available space and align with the user's organizational needs. The model can suggest artwork, window treatments, and other decorative items that complement the overall design style and add a personalized touch to the space.

The model can consider accessibility requirements and ergonomic factors when generating the design plan, ensuring that the space is comfortable and usable for all occupants. The model can prioritize eco-friendly materials, energy-efficient lighting, and other sustainable design elements based on user preferences or local regulations.

The model can provide an estimated cost breakdown for the design plan, including materials, labor, and other expenses, helping the user make informed decisions and stay within their budget.

The interior design plan 320 can include a task 324 and a task ID 322. The task 324 includes a specific activity or action item that needs to be completed as part of the interior design project. The tasks can include consultation, site measurement, design development, material sourcing, contractor hiring, and construction or installation.

The interior design plan 320 can include start times 326 that refer to the date or time when a particular task is scheduled to begin and finish times 328 that refer to the date or time when the task is expected to be completed. These times help to define the project schedule and ensure that each task is completed in a timely manner.

The interior design plan 320 can include a duration 330 for each of the tasks 324. The duration 330 refers to the amount of time it takes to complete a specific task, from its start time to its finish time. The duration 330 can be expressed in various units, such as days, weeks, or months, depending on the complexity and scope of the task.

The interior design plan 320 can include a percentage complete 332, which represents the progress made on a specific task relative to its total duration. This metric allows project managers and team members to monitor the progress of individual tasks and the overall project, identify potential delays or bottlenecks, and make adjustments as needed to stay on schedule.

The interior design plan 320 can include a project management timeline 334 which is a visual representation of the project schedule, showing the start and finish times, durations, and progress of each task. Timelines can be displayed in various formats, such as Gantt charts, calendars, or task lists. The AI system generates the project management timeline to help project managers and team members track progress, identify dependencies, allocate resources, and ensure timely completion of the interior design project.

By taking into account contractor availability and lead times for products, the model can generate a design plan that fits within the user's desired project timeline. Moreover, since the interior design plan 320 communicates with manufacturer systems and contractor systems, the interior design plan 320 can be updated and adjusted in real-time based on updated information (such as delays in lead time).

By considering a variety of inputs, a machine learning model can generate a comprehensive and tailored interior design plan that addresses the user's preferences, functional requirements, and constraints while streamlining the selection, construction, and renovation processes.

A machine learning algorithm can generate a 3D model of a physical space based on various inputs. The machine learning algorithm creates a set of features that will help the algorithm understand the relationship between the inputs and the desired 3D model. These features may include spatial dimensions, room types, furniture and fixture specifications, and contractor requirements. Feature engineering may involve creating combinations of existing features or applying mathematical transformations.

The 3D model is a digital representation of the physical space, composed of points in three-dimensional space (X, Y, and Z coordinates) connected by lines, polygons, and surfaces to create a realistic visual representation. When the machine learning model generates an interior design plan based on various inputs, the resulting 3D model provides a detailed, virtual visualization of the physical space, including its layout, furniture arrangement, materials, and colors.

The 3D model generated by a machine learning algorithm depicts the arrangement of walls, windows, doors, and other architectural elements, based on the dimensions and constraints of the space. The 3D model includes furniture, appliances, and fixtures that match the user's intent, preferences, and the product information provided by merchants. The machine learning model generates placement of these items that is optimized to create a functional and aesthetically pleasing interior.

The 3D model incorporates material selections and color schemes for walls, floors, ceilings, and furnishings, based on user preferences and any given constraints, which contribute to the overall ambiance of the space. The 3D model displays the position and type of lighting fixtures, considering the requirements of the physical space and the user's preferences to create an optimal lighting design.

The 3D model may also include decorative elements such as artwork, curtains, rugs, and other accessories, selected based on user preferences and the overall design theme.

The 3D model can be annotated with contractor information, such as measurements, installation instructions, and relevant specifications, which can be useful for the professionals who will execute the job, ensuring that the final result closely matches the generated 3D model.

The generated 3D model can be visualized using specialized software or Extended Reality (XR) applications, allowing users to explore and interact with the space before any physical work is done. This helps in making informed decisions about the design, reducing the chances of costly mistakes, and ensuring that the final result meets the user's expectations.

Extended Reality (XR) is an umbrella term encapsulating Augmented Reality (AR), Virtual Reality (VR), Mixed Reality (MR), and everything in between. For the sake of simplicity, examples are described using one type of system, such as XR or AR. However, it is appreciated that other types of systems apply.

In some examples, the 3D model is shown in a VR application, where the entire visual space is digitally generated. In some examples, the generated 3D model can be applied in Augmented Reality while the user is standing in the physical space. A camera feed from a user device is augmented by the 3D model. Digital elements of the interior design plan can be overlaid onto real-world objects or surfaces on a camera feed of the user device.

In some examples, the user interface of the user displays a visualization of information for the chosen products and professional installers and builders. The user interface provides options for the user to select products and interview professionals for the interior design plan.

The AI system and/or the machine learning algorithm can automate the ordering process and reserve professionals for the job when a user approves the plan or selects specific manufacturers, products, or contractors. The AI system and/or the machine learning algorithm can communicate with the manufacturer server 304 to create a purchase order 310 for products needed for the interior design plan.

The AI system can communicate with the manufacturer server 304 to generate custom finishes or products. The AI system and/or the machine learning algorithm can communicate with the contractor server 312 to schedule a professional 318 for services needed for the interior design plan.

The AI system can communicate with the manufacturer server 304 to receive a quote for a particular product. The AI system can communicate with contractor servers 312 to receive a quote for a particular service. The AI system can use such quotes to generate a budget based on an expected total budget for the project.

The AI performs such purchasing and scheduling integrating the machine learning system with Application Programming Interfaces (APIs) provided by the manufacturer and contractor servers. These APIs allow the AI system to access and interact with the servers' data and functionalities. This API integration also enables the machine learning algorithm to fetch product information, availability, and contractor schedules from the respective servers during the design generation process.

When a user accepts the generated interior design plan or selects individual manufacturers, products, or contractors, the machine learning system sends requests to the manufacturer servers through their APIs to place orders for the selected products. The manufacturer servers process the order requests and send back confirmation messages to the AI system, indicating that the orders have been successfully placed.

The machine learning system communicates with the contractor servers through their APIs to reserve professionals for the job. The AI system can send requests containing the job details, such as the scope of work, timeline, and user's contact information. The contractor servers then allocate the appropriate professionals for the job based on their availability and skillset, and send back confirmation messages to the machine learning system.

By integrating with manufacturer and contractor APIs, the AI system and/or the machine learning algorithm can automate the ordering and reservation processes, providing a seamless experience for the user while minimizing manual intervention and the possibility of errors.

Users can provide feedback for the machine learning model or request revisions to their interior design plans. The platform allows users to indicate their preferences or dislikes about specific aspects of the generated design, such as furniture placement, color schemes, materials, or lighting.

To utilize this user feedback for retraining the machine learning model, the AI system collects and preprocesses the feedback data to transform it into a format suitable for the learning process. The AI system categorizes the feedback into specific design aspects, quantifying user preferences, and establishing correlations between the feedback and the initial input parameters. Once the feedback data is processed and structured, the AI system incorporates the feedback data into the training dataset as additional examples or used to modify the loss function, which guides the model's learning. By retraining the model with the updated dataset or loss function, the system can iteratively improve its design generation capabilities, refining its understanding of user preferences, and ultimately creating more satisfactory interior design plans that align with users' expectations and needs.

### Generating 3D Model for a Virtual Tour

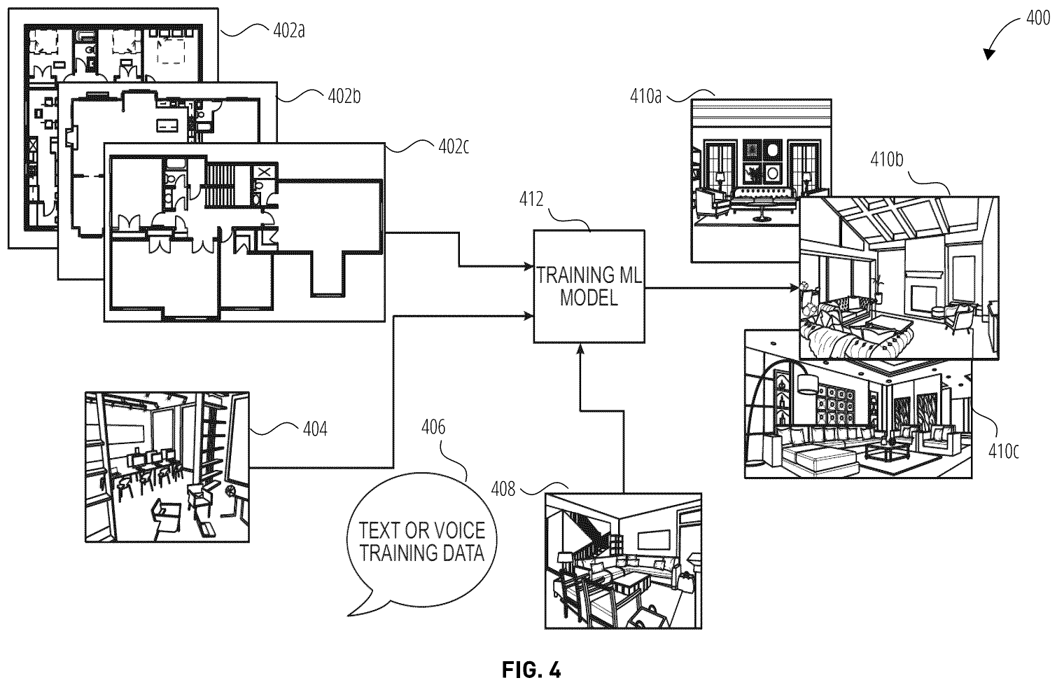

FIG. 4 illustrates a machine learning model that generates a 3D model for a physical space enabling a user to take a virtual tour 400, according to some examples. In some examples, the machine learning model that receives multiple floor plans 402a, 402b, and 402c (collectively referred to herein as floor plans 402), 3D models 404 or LIDAR camera scans of a physical space, user preferences 406 via text or voice, or images/videos 408 indicative of a user's desired style. The machine learning model then outputs a 3D model 410a, 410b, and 410c (collectively referred to herein as 3D model 410) where a user can take a virtual tour around multiple rooms.

The machine learning model 412 collects and preprocesses the data, such as the floor plans 402, 3D models 404 or LIDAR camera scans, user preferences 406, and/or images/videos 408, in a suitable format for the machine learning algorithm. This may involve normalizing numerical data, encoding categorical data, and converting text data into numerical vectors using techniques like word embeddings or tokenization.

The machine learning model 412 creates a set of features that will enable the algorithm to combine the input data in different formats to generate the desired 3D model. These features may include spatial dimensions, room types, furniture and fixture specifications, user preferences, and any other relevant features.

Then, the machine learning algorithm generates the 3D models based on the input data. The deployed model will take the floor plans 402, 3D models 404 or LIDAR camera scans, user preferences 406, and/or images/videos 408 as input, and generate a 3D model of the physical space as output. The model can output a 3D model where the user can take a virtual tour around multiple rooms.

The generated 3D model can be visualized using specialized software or Extended Reality (XR) applications, allowing users to explore and interact with the space by taking a virtual tour around multiple rooms. The model can incorporate the user's preferences and design choices, enabling users to see how their design preferences would appear in the physical space. The users can then make adjustments before final decisions are made.

In some examples, the 3D models illustrate the current physical space in construction. For example, if flooring is installed before the cabinets, the 3D model shows updated flooring at the time the flooring is installed without the cabinets. The users have the option to see the space in various stages of construction as well as to see the finished products. The users also have the option to select and unselect certain features of the construction to view only the selected features in the physical space.

### System Architecture

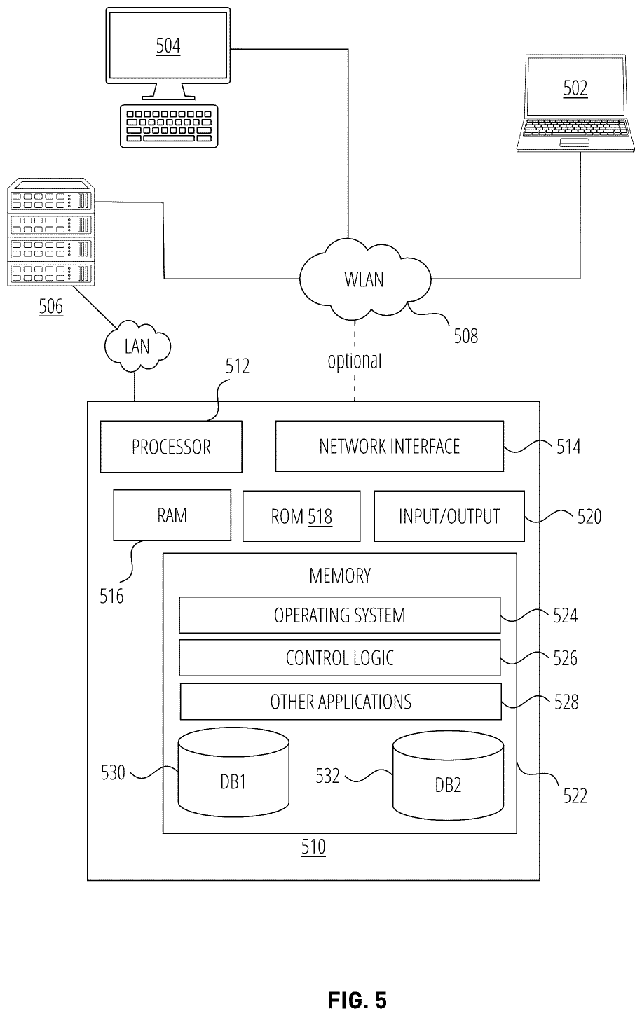

FIG. 5 illustrates one example of an AI system architecture and data processing device that may be used to implement one or more illustrative aspects described herein in a standalone and/or networked environment. Various network nodes, such as a data server 510, web server 506, computer 504, and laptop 502, may be interconnected via a wide area network 508 (WAN), such as the internet. Other networks may also or alternatively be used, including private intranets, corporate networks, LANs, metropolitan area networks (MANs) wireless networks, personal networks (PANs), and the like. Network 508 is for illustration purposes and may be replaced with fewer or additional computer networks. A local area network (LAN) may have one or more of any known LAN topology and may use one or more of a variety of different protocols, such as Ethernet. Devices, such as data server 510, web server 506, computer 504, laptop 502 and other devices (not shown), may be connected to one or more of the networks via twisted pair wires, coaxial cable, fiber optics, radio waves or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 510, web server 506, client computer 504, and laptop 502. The data server 510 provides overall access, control and administration of databases and control software for performing one or more illustrative aspects described herein. The data server, such as data server 510, may be connected to web server 506 through which users interact with and obtain data as requested. Alternatively, data server 510 may act as a web server itself and be directly connected to the internet. The data server 510 may be connected to web server 506 through the network 508 (e.g., the internet), via direct or indirect connection, or via some other network. Users may interact with the data server 510 using remote computer 504 or laptop 502, e.g., using a web browser to connect to the data server 510 via one or more externally exposed web sites hosted by web server 506. The client computer 504 or laptop 502 may be used in concert with data server 510 to access data stored therein, or may be used for other purposes. For example, from client computer 504, a user may access web server 506 using an internet browser, as is known in the art, or by executing a software application that communicates with web server 506 and/or data server 510 over a computer network (such as the internet).

Servers and applications may be combined on the same physical machines, and retain separate virtual or logical addresses, or may reside on separate physical machines. FIG. 5 illustrates just one example of a network architecture that may be used, and those of skill in the art will appreciate that the specific network architecture and data processing devices used may vary, and are secondary to the functionality that they provide, as further described herein. For example, services provided by web server 506 and data server 510 may be combined on a single server.

Each component, such as the data server 510, web server 506, computer 504, or laptop 502, may be any type of known computer, server, or data processing device. Data server 510, e.g., may include a processor 512 controlling overall operation of the data server 510. The data server 510 may further include RAM 516, ROM 518, network interface 514, input/output interfaces 520 (e.g., keyboard, mouse, display, printer, etc.), and memory 522. The input/output interfaces 520 may include a variety of interface units and drives for reading, writing, displaying, and/or printing data or files. The memory 522 may further store operating system software 524 for controlling overall operation of the data server 510, control logic 526 for instructing the data server to perform aspects described herein, and other application software 528 providing secondary, support, and/or other functionality which may or may not be used in conjunction with aspects described herein. The control logic may also be referred to herein as the data server software or control logic 526. The functionality of the data server software may refer to operations or decisions made automatically based on rules coded into the control logic, made manually by a user providing input into the system, and/or a combination of automatic processing based on user input (e.g., queries, data updates, etc.).

The memory 522 may also store data used in performance of one or more aspects described herein, including a first database 532 and a second database 530. In some embodiments, the first database may include the second database (e.g., as a separate table, report, etc.). That is, the information can be stored in a single database, or separated into different logical, virtual, or physical databases, depending on system design. The web server 506, computer 504, or laptop 502 may have similar or different architecture as described with respect to data server 510. Those of skill in the art will appreciate that the functionality of data server 510 (or web server 506, computer 504, or laptop 502) as described herein may be spread across multiple data processing devices, for example, to distribute processing load across multiple computers, to segregate transactions based on geographic location, user access level, quality of service (QOS), etc.

One or more aspects may be embodied in computer-usable or readable data and/or computer-executable instructions, such as in one or more program modules, executed by one or more computers or other devices as described herein. Generally, program modules include routines, programs, objects, components, or data structures that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a nonvolatile storage device. Any suitable computer readable storage media may be utilized, including hard disks, CD-ROMs, optical storage devices, magnetic storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

### Machine-Learning Pipeline

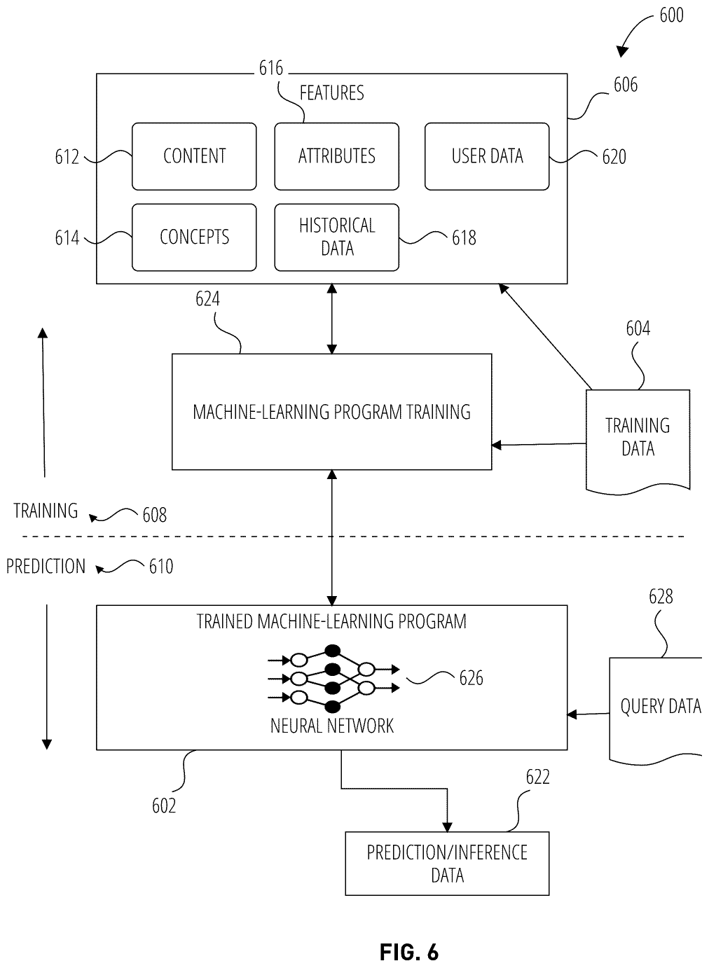

FIG. 6 is a flowchart depicting a machine-learning pipeline 600, according to some examples. The machine-learning pipelines 600 may be used to generate a trained model, for example the trained machine-learning program 602 of FIG. 6, described herein to perform operations associated with searches and query responses.

### Overview

Broadly, machine learning may involve using computer algorithms to automatically learn patterns and relationships in data, potentially without the need for explicit programming to do so after the algorithm is trained. Examples of machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data. Evaluating the model on a separate test set helps to mitigate the risk of overfitting, a common issue in machine learning where a model learns to perform exceptionally well on the training data but fails to maintain that performance on data it hasn't encountered before. By using a test set, the system obtains a more reliable estimate of the model's real-world performance and its potential effectiveness when deployed in practical applications.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

### Phases

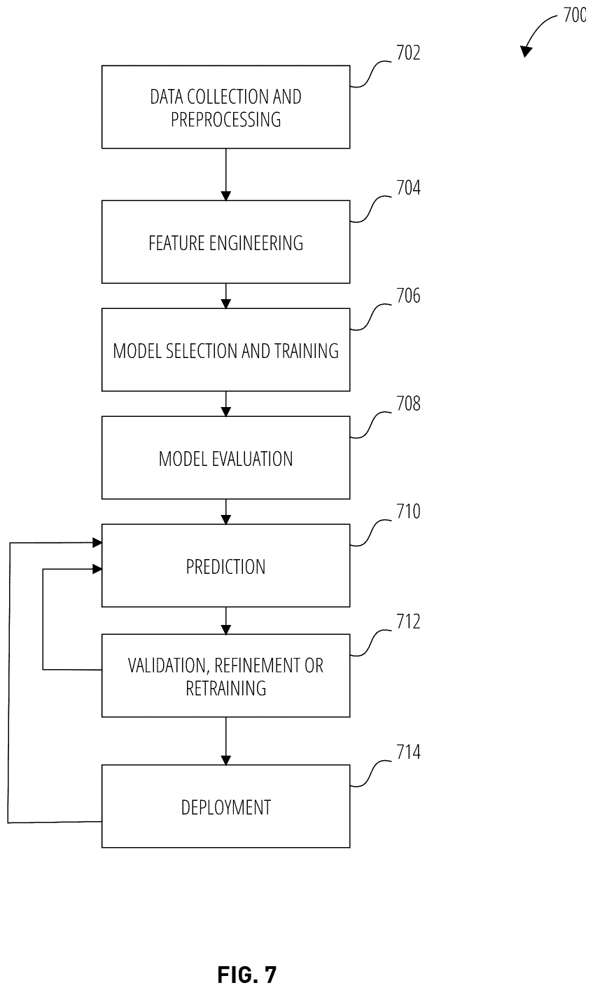

Generating a trained machine-learning program 602 may include multiple types of phases that form part of the machine-learning pipeline 600, including for example the following phases 700 illustrated in FIG. 7:
Data collection and preprocessing 702: This may include acquiring and cleaning data to ensure that it is suitable for use in the machine learning model. Data can be gathered from user content creation and labeled using a machine learning algorithm trained to label data. Data can be generated by applying a machine learning algorithm to identify or generate similar data. This may also include removing duplicates, handling missing values, and converting data into a suitable format.
Feature engineering 704: This may include selecting and transforming the training data 604 to create features that are useful for predicting the target variable. Feature engineering may include (1) receiving features 606 (e.g., as structured or labeled data in supervised learning) and/or (2) identifying features 606 (e.g., unstructured or unlabeled data for unsupervised learning) in training data 604.
Model selection and training 706: This may include specifying a particular problem or desired response from input data, selecting an appropriate machine learning algorithm, and training it on the preprocessed data. This may further involve splitting the data into training and testing sets, using cross-validation to evaluate the model, and tuning hyperparameters to improve performance. Model selection can be based on factors such as the type of data, problem complexity, computational resources, or desired performance.
Model evaluation 708: This may include evaluating the performance of a trained model (e.g., the trained machine-learning program 602) on a separate testing dataset. This can help determine if the model is overfitting or underfitting and if it is suitable for deployment.
Prediction 710: This involves using a trained model (e.g., trained machine-learning program 602) to generate predictions on new, unseen data.
Validation, refinement or retraining 712: This may include updating a model based on feedback generated from the prediction phase, such as new data or user feedback.
Deployment 714: This may include integrating the trained model (e.g., the trained machine-learning program 602) into a larger system or application, such as a web service, mobile app, or IoT device. This can involve setting up APIs, building a user interface, and ensuring that the model is scalable and can handle large volumes of data.

FIG. 6 illustrates two example phases, namely a training phase 608 (part of the model selection and trainings 706) and a prediction phase 610 (part of prediction 710). Prior to the training phase 608, feature engineering 704 is used to identify features 606. This may include identifying informative, discriminating, and independent features for the effective operation of the trained machine-learning program 602 in pattern recognition, classification, and regression. In some examples, the training data 604 includes labeled data, which is known data for pre-identified features 606 and one or more outcomes.

Each of the features 606 may be a variable or attribute, such as individual measurable property of a process, article, system, or phenomenon represented by a data set (e.g., the training data 604). Features 606 may also be of different types, such as numeric features, strings, vectors, matrices, encodings, and graphs, and may include one or more of content 612, concepts 614, attributes 616, historical data 618 and/or user data 620, merely for example. Concept features can include abstract relationships or patterns in data. Content features include determining a context based on input information, such as determining a context of a user based on user interactions or surrounding environmental factors. Context features can include text features, such as frequency or preference of words or phrases, image features, such as pixels, textures, or pattern recognition, audio classification, such as spectrograms, and/or the like. Attribute features include intrinsic attributes (directly observable) or extrinsic features (derived), such as identifying square footage, location, or age of a real estate property identified in a camera feed. User data features include data pertaining to a particular individual or to a group of individuals, such as in a geographical location or that share demographic characteristics. User data can include demographic data (such as age, gender, location, or occupation), user behavior (such as browsing history, purchase history, conversion rates, click-through rates, or engagement metrics), or user preferences (such as preferences to certain video, text, or digital content items). Historical data includes past events or trends that can help identify patterns or relationships over time.

In training phases 608, the machine-learning pipeline 600 uses the training data 604 to find correlations among the features 606 that affect a predicted outcome or prediction/inference data 622.

With the training data 604 and the identified features 606, the trained machine-learning program 602 is trained during the training phase 608 during machine-learning program training 624. The machine-learning program training 624 appraises values of the features 606 as they correlate to the training data 604. The result of the training is the trained machine-learning program 602 (e.g., a trained or learned model).

Further, the training phase 608 may involve machine learning, in which the training data 604 is structured (e.g., labeled during preprocessing operations), and the trained machine-learning program 602 implements a relatively simple neural network 626 capable of performing, for example, classification and clustering operations. In other examples, the training phase 608 may involve deep learning, in which the training data 604 is unstructured, and the trained machine-learning program 602 implements a deep neural network 626 that is able to perform both feature extraction and classification/clustering operations.

A neural network 626 may, in some examples, be generated during the training phase 608, and implemented within the trained machine-learning program 602. The neural network 626 includes a hierarchical (e.g., layered) organization of neurons, with each layer including multiple neurons or nodes. Neurons in the input layer receive the input data, while neurons in the output layer produce the final output of the network. Between the input and output layers, there may be one or more hidden layers, each including multiple neurons.

Each neuron in the neural network 626 operationally computes a small function, such as an activation function that takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, which can affect their performance on different tasks. Overall, the layered organization of neurons and the use of activation functions and weights enable neural networks to model complex relationships between inputs and outputs, and to generalize to new inputs that were not seen during training.

In some examples, the neural network 626 may also be one of a number of different types of neural networks or a combination thereof, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 608, a validation phase may be performed evaluated on a separate dataset known as the validation dataset. The validation dataset is used to tune the hyperparameters of a model, such as the learning rate and the regularization parameter. The hyperparameters are adjusted to improve the performance of the model on the validation dataset.

The neural network 626 is iteratively trained by adjusting model parameters to minimize a specific loss function or maximize a certain objective. The system can continue to train the neural network 626 by adjusting parameters based on the output of the validation, refinement, or retraining block 712, and rerun the prediction 710 on new or already run training data. The system can employ optimization techniques for these adjustments such as gradient descent algorithms, momentum algorithms, Nesterov Accelerated Gradient (NAG) algorithm, and/or the like. The system can continue to iteratively train the neural network 626 even after deployment 714 of the neural network 626. The neural network 626 can be continuously trained as new data emerges, such as based on user creation or system-generated training data.

Once a model is fully trained and validated, in a testing phase, the model may be tested on a new dataset that the model has not seen before. The testing dataset is used to evaluate the performance of the model and to ensure that the model has not overfit the training data.

In prediction phase 610, the trained machine-learning program 602 uses the features 606 for analyzing query data 628 to generate inferences, outcomes, or predictions, as examples of a prediction/inference data 622. For example, during prediction phase 610, the trained machine-learning program 602 is used to generate an output. Query data 628 is provided as an input to the trained machine-learning program 602, and the trained machine-learning program 602 generates the prediction/inference data 622 as output, responsive to receipt of the query data 628. Query data can include a prompt, such as a user entering a textual question or speaking a question audibly. In some cases, the system generates the query based on an interaction function occurring in the system, such as a user interacting with a virtual object, a user sending another user a question in a chat window, or an object detected in a camera feed.

In some examples the trained machine-learning program 602 may be a generative AI model. Generative AI is a term that may refer to any type of artificial intelligence that can create new content from training data 604. For example, generative AI can produce text, images, video, audio, code or synthetic data that are similar to the original data but not identical.

Some of the techniques that may be used in generative AI are:
Convolutional Neural Networks (CNNs): CNNs are commonly used for image recognition and computer vision tasks. They are designed to extract features from images by using filters or kernels that scan the input image and highlight important patterns. CNNs may be used in applications such as object detection, facial recognition, and autonomous driving.
Recurrent Neural Networks (RNNs): RNNs are designed for processing sequential data, such as speech, text, and time series data. They have feedback loops that allow them to capture temporal dependencies and remember past inputs. RNNs may be used in applications such as speech recognition, machine translation, and sentiment analysis
Generative adversarial networks (GANs): These are models that consist of two neural networks: a generator and a discriminator. The generator tries to create realistic content that can fool the discriminator, while the discriminator tries to distinguish between real and fake content. The two networks compete with each other and improve over time. GANs may be used in applications such as image synthesis, video prediction, and style transfer.
Variational autoencoders (VAEs): These are models that encode input data into a latent space (a compressed representation) and then decode it back into output data. The latent space can be manipulated to generate new variations of the output data. They may use self-attention mechanisms to process input data, allowing them to handle long sequences of text and capture complex dependencies.
Transformer models: These are models that use attention mechanisms to learn the relationships between different parts of input data (such as words or pixels) and generate output data based on these relationships. Transformer models can handle sequential data such as text or speech as well as non-sequential data such as images or code.

In generative AI examples, the prediction/inference data 622 that is output include trend assessment and predictions, translations, summaries, image or video recognition and categorization, natural language processing, face recognition, user sentiment assessments, advertisement targeting and optimization, voice recognition, or media content generation, recommendation, and personalization.

### Applying Pixel Data to Enhance Machine Learning Models

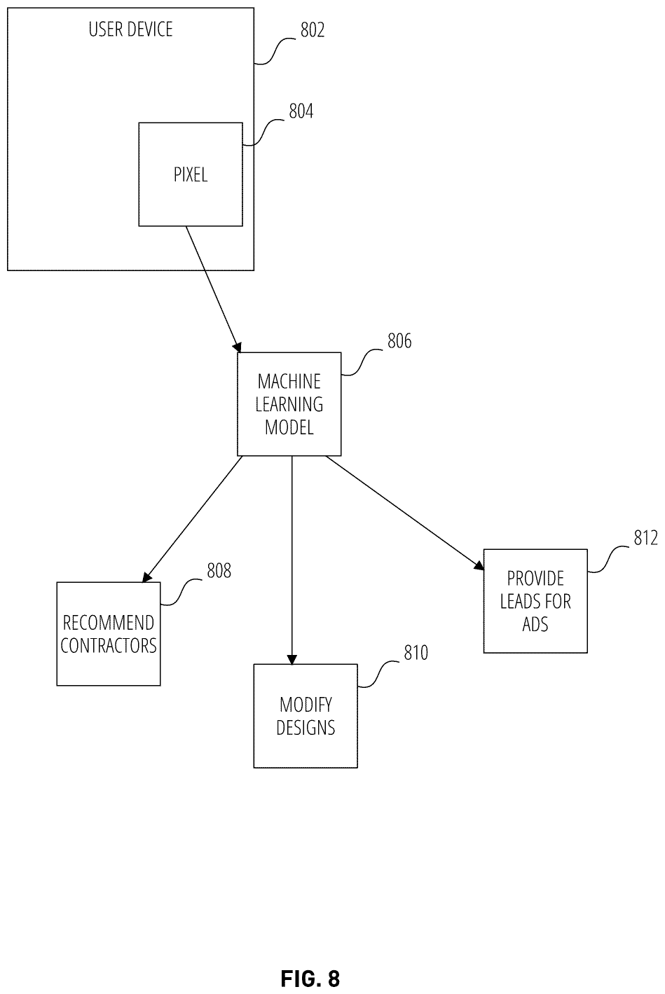

FIG. 8 illustrates the use of pixel data to enhance the machine learning model, according to some examples. To enhance the machine learning models, the system can apply pixel data, such as in the context of deanonymizing website traffic for automated lead generation. A pixel 804, in the context of online tracking and analytics, can include a small, transparent image or code snippet embedded on a website or within an email displayed on a user device 802. The pixel serves several purposes related to data gathering and tracking user behavior.

A pixel can be invisible to the user as it's transparent and often just a single pixel in size. It's designed not to affect the visual appearance of a webpage or email. When a webpage or email containing a pixel is loaded or opened by a user, the pixel code is also executed, triggering a request to a server to retrieve the pixel image or execute a tracking script.

Pixels can be used for data collection and analytics purposes. The pixels can gather information such as page views (when a pixel is placed on a webpage, it can track how many times that page is viewed), user interactions (pixels can track user interactions such as clicks on specific links, buttons, or elements on a webpage), conversion tracking (for e-commerce or marketing campaigns, pixels can track conversions, such as completed purchases or form submissions), user attributes (pixels can also collect data about the user's device, browser, location (IP address), and referral source (where they came from before visiting the webpage)), and/or the like.

Pixels can be applied to user devices in several ways. When a pixel is placed on a website, it is loaded along with the webpage's content when a user visits that site. This allows the pixel to track user interactions and behavior on the website.

In emails, pixels can be used to track opens (when the email is viewed) and clicks on links within the email. This helps marketers and businesses understand the effectiveness of their email campaigns.

Pixels are can be used in retargeting campaigns, where they track users who have visited a website and then display targeted ads to them on other platforms based on their behavior on the site. Some pixels can track users across multiple devices, helping to create a more comprehensive profile of user behavior and preferences.

The interaction system can apply a machine learning model for targeted advertising, including deanonymization of user data. The interaction system collects extensive data about its users, including demographic information, interests, online behaviors, interactions with ads and posts, location data, device information, and more. Initially, this data is anonymized, meaning it's stripped of any personally identifiable information (PII) like names or contact details. This anonymization is crucial for user privacy and compliance with data protection regulations.

The interaction system aggregates this anonymized data from millions of users, creating large datasets that reflect trends, preferences, and patterns across different user segments. The interaction system employs machine learning algorithms, such as the machine learning model 806, to analyze this aggregated data. These algorithms can detect patterns and correlations within the data, even without explicit PII.

Through this analysis, the interaction system can deanonymize certain aspects of user behavior. For example, the interaction system can infer that a group of users with specific interests or behaviors likely belong to a certain demographic or have certain preferences.

Based on the deanonymized insights, the interaction system allows advertisers to target specific user segments with tailored ads. Advertisers can define their target audience based on criteria like age, interests, location, past behavior, etc. When users interact with these targeted ads (e.g., clicking, liking, sharing), the interaction system collects feedback data that further refines its targeting algorithms.

The interaction system collects data from website visitors, aggregating and analyzing this data to infer user preferences or needs, and uses a large language model to assist in this analysis for automated lead generation or personalized services. In some cases, the interaction system accesses pixel data retrieved and stored by third parties to identify characteristics of its customer base for specialized recommendations.

In some cases, the deanonymization pixel can be embedded on a professional's website to collect data from visitors, including their IP addresses. IP address data is combined with other big data sources to deanonymize information.

The goal is to use this deanonymized data to generate automated leads 812. For example, identifying homeowners who are looking for plumbing services in a specific area. The interaction system applies the LLM or another AI model to parse this data. While the system may already identify homeowners, the LLM analyzes what these homeowners are doing within the builder market, possibly by examining their interactions with specific pages in a person's directory or related to construction services.

The interaction system applies the LLM to assist in processing this parsed data to generate leads. The LLM refines the data by understanding the context of the homeowner's activities, their preferences, and their potential needs related to home improvement or construction projects. This refined information is then fed back to the system as actionable leads for professionals like general contractors 808 or service providers.

In some cases, pixel data can also be used to track upstream market trends and user preferences in design. This data can modify and enhance the design process 810 by providing insights into what users are interested in, helping AI models suggest design ideas or solutions that align with the user's project goals. The pixel data continually shapes and refines the AI's understanding of what clients want for their designs, improving the accuracy and relevance of design suggestions over time.

In summary, the concept leverages pixel data to deanonymize website visitors, uses LLMs to analyze and refine this data for lead generation, and utilizes pixel data further to automate design processes and enhance AI-driven suggestions for users' projects. It's a comprehensive approach that combines data collection, AI analysis, and automated decision-making to improve targeting and user experience in professional services like home improvement or construction.

Pixel data can indeed enhance various features of machine learning models. Pixel data can serve as additional input features for machine learning models. For example, in the context of website visitor tracking, pixel data can provide insights into user behavior, interactions, and preferences. This enriched data can help train models more effectively by capturing nuanced patterns and correlations.

Pixel data can provide contextual information about user activities and engagement. For instance, in automated lead generation, understanding how users interact with specific pages or elements on a website (captured through pixels) can provide valuable context for predicting their needs or interests accurately.

Machine learning models can use pixel data to personalize recommendations and suggestions. For instance, in design automation, pixel data that reflects user preferences or trends in design choices can inform AI models to generate more tailored suggestions and designs for users' projects.

Pixel data can offer insights into user behavior across platforms and devices. This cross-platform tracking can help machine learning models understand user journeys better, leading to more accurate predictions and decisions.

Pixel data can be used to augment training data for machine learning models. By incorporating pixel-derived features into the training dataset, models can learn from a more diverse and comprehensive set of inputs, improving their robustness and generalization capabilities.

In scenarios like retargeting or personalized advertising, pixel data can provide real-time updates on user interactions. This timely feedback can be integrated into machine learning models to adjust targeting strategies or recommendations dynamically.

Overall, pixel data can enhance machine learning models by providing richer data inputs, contextual information, personalized insights, and real-time updates, leading to improved accuracy, effectiveness, and user experience in various applications.

### Examples

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: at least one processor; and at least one memory component storing instructions that, when executed by the at least one processor, cause the at least one processor to perform operations comprising: identifying a prompt of a user indicating an intent of the user for a physical space; receiving dimensional information regarding the physical space; applying a collection of data corresponding to the prompt and dimensional information to a first machine learning model to generate an interior design plan for the physical space; and causing display of a three-dimensional virtual space with virtual objects or patterns based on the interior design plan, wherein dimensions of the three-dimensional virtual space match the dimensional information of the physical space.

In Example 2, the subject matter of Example 1 includes, wherein identifying the prompt includes receiving text input from the user.

In Example 3, the subject matter of Examples 1-2 includes, wherein the operations further comprise recording or receiving a recording of verbal speech by the user, wherein identifying the prompt includes extracting a textual prompt from the recording of the verbal speech.

In Example 4, the subject matter of Examples 1-3 includes, wherein the prompt comprises images or videos indicative of the user's desired characteristics for the physical space.

In Example 5, the subject matter of Example 4 includes, wherein the operations further comprise: processing the images or videos through a second machine learning model, wherein the second machine learning model is trained to extracted features from images or videos; and associating the extracted features from the images or videos to the user's intent.

In Example 6, the subject matter of Examples 1-5 includes, wherein the dimensional information includes a floor plan providing a top-down view of the physical space.

In Example 7, the subject matter of Examples 1-6 includes, wherein the dimensional information includes Light Detection and Ranging (LiDAR) data that includes measured distances using lasers.

In Example 8, the subject matter of Examples 1-7 includes, wherein the first machine learning model is trained to generate interior design plans based on data corresponding to physical dimensions of physical spaces and design constraints for the physical spaces.

In Example 9, the subject matter of Examples 1-8 includes, wherein the operations further comprise: training the first machine learning model by: identifying training prompts, training dimensional information, and training expected interior design plans; applying the training prompts and the training dimensional information to the first machine learning model to receive output interior design plans; compare the output interior design plans with the expected training interior design plans to determine a loss parameter for the first machine learning model; and update a characteristic of the first machine learning model based on the loss parameter.

In Example 10, the subject matter of Examples 1-9 includes, wherein the operations further comprise: accessing product data from one or more external manufacturer servers, wherein the collection of data corresponding to the prompt and dimensional information also includes the product data, wherein the first machine learning model generates the interior design plan for the physical space also based on the product data.

In Example 11, the subject matter of Example 10 includes, wherein the product data includes product availability, pricing, and lead times.

In Example 12, the subject matter of Examples 10-11 includes, wherein the operations further comprise, in response to the user accepting the interior design plan, automatically initiate creation of a purchase order for one or more products associated with the product data via communication with the one or more external manufacturer servers.

In Example 13, the subject matter of Examples 1-12 includes, wherein the operations further comprise: accessing contractor data from one or more external contractor servers, wherein the collection of data corresponding to the prompt and dimensional information also includes the contractor data, wherein the first machine learning model generates the interior design plan for the physical space also based on the contractor data.

In Example 14, the subject matter of Example 13 includes, wherein the contractor data includes a specialty, an availability, and a geographic region of coverage for a contractor.

In Example 15, the subject matter of Examples 13-14 includes, wherein the operations further comprise, in response to the user accepting the interior design plan, automatically initiate scheduling of a professional person for one or more services associated with the contractor data via communication with the one or more external contractor servers.

In Example 16, the subject matter of Examples 1-15 includes, wherein the operations further comprise: accessing contractor data from one or more external contractor servers; and accessing product data from one or more external manufacturer servers, wherein the collection of data corresponding to the prompt and dimensional information also includes the contractor data and the product data, wherein the first machine learning model generates the interior design plan for the physical space also based on the contractor data and product data.

In Example 17, the subject matter of Example 16 includes, wherein the interior design plan includes a list of tasks for the interior design plan and a timeline for each of the tasks based on availability indicated in the product data and the contractor data.

In Example 18, the subject matter of Examples 1-17 includes, D model that depicts an arrangement of architectural elements for the physical space based on the interior design plan.

In Example 19, the subject matter of Example 18 includes, D model in a Virtual Reality (VR) application, wherein the architectural elements and the physical space are digital representations.

In Example 20, the subject matter of Examples 18-19 includes, D model to show the architectural elements overlaid on at least a portion of the real-world camera feed.

Example 21 is a method comprising: identifying a prompt of a user indicating an intent of the user for a physical space; receiving dimensional information regarding the physical space; applying a collection of data corresponding to the prompt and dimensional information to a first machine learning model to generate an interior design plan for the physical space; and causing display of a three-dimensional virtual space with virtual objects or patterns based on the interior design plan, wherein dimensions of the three-dimensional virtual space match the dimensional information of the physical space.

Example 22 is a non-transitory computer-readable storage medium storing instructions that, when executed by at least one processor, cause the at least one processor to perform operations comprising: identifying a prompt of a user indicating an intent of the user for a physical space; receiving dimensional information regarding the physical space; applying a collection of data corresponding to the prompt and dimensional information to a first machine learning model to generate an interior design plan for the physical space; and causing display of a three-dimensional virtual space with virtual objects or patterns based on the interior design plan, wherein dimensions of the three-dimensional virtual space match the dimensional information of the physical space.

Example 23 is at least one machine-readable medium including instructions that, when executed by processing circuitry, cause the processing circuitry to perform operations to implement any of Examples 1-22.

Example 24 is an apparatus comprising means to implement any of Examples 1-22.

Example 25 is a system to implement any of Examples 1-22.

Example 26 is a method to implement any of Examples 1-22.

### CONCLUSION

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

The various features, steps, and processes described herein may be used independently of one another, or may be combined in various ways. All possible combinations and subcombinations are intended to fall within the scope of this disclosure. In addition, certain method or process blocks may be omitted in some implementations.

What is claimed is:

1. A system comprising:
at least one processor; and
at least one memory component storing instructions that, when executed by the at least one processor, cause the at least one processor to perform operations comprising:
identifying a prompt of a user indicating an intent of the user for a physical space;
receiving dimensional information regarding the physical space;
applying a collection of data corresponding to the prompt and dimensional information to a first machine learning model to generate an interior design plan for the physical space; and
causing display of a three-dimensional virtual space with virtual objects or patterns based on the interior design plan, wherein dimensions of the three-dimensional virtual space match the dimensional information of the physical space.

2. The system of claim 1, wherein identifying the prompt includes receiving text input from the user.

3. The system of claim 1, wherein the operations further comprise recording or receiving a recording of verbal speech by the user, wherein identifying the prompt includes extracting a textual prompt from the recording of the verbal speech.

4. The system of claim 1, wherein the prompt comprises images or videos indicative of the user's desired characteristics for the physical space.

5. The system of claim 4, wherein the operations further comprise:
processing the images or videos through a second machine learning model, wherein the second machine learning model is trained to extracted features from images or videos; and
associating the extracted features from the images or videos to the user's intent.

6. The system of claim 1, wherein the dimensional information includes a floor plan providing a top-down view of the physical space.

7. The system of claim 1, wherein the dimensional information includes Light Detection and Ranging (LiDAR) data that includes measured distances using lasers.

8. The system of claim 1, wherein the first machine learning model is trained to generate interior design plans based on data corresponding to physical dimensions of physical spaces and design constraints for the physical spaces.

9. The system of claim 1, wherein the operations further comprise:
training the first machine learning model by:
identifying training prompts, training dimensional information, and training expected interior design plans;
applying the training prompts and the training dimensional information to the first machine learning model to receive output interior design plans;
compare the output interior design plans with the expected training interior design plans to determine a loss parameter for the first machine learning model; and
update a characteristic of the first machine learning model based on the loss parameter.

10. The system of claim 1, wherein the operations further comprise:
accessing product data from one or more external manufacturer servers,
wherein the collection of data corresponding to the prompt and dimensional information also includes the product data, wherein the first machine learning model generates the interior design plan for the physical space also based on the product data.

11. The system of claim 10, wherein the product data includes product availability, pricing, and lead times.

12. The system of claim 10, wherein the operations further comprise, in response to the user accepting the interior design plan, automatically initiate creation of a purchase order for one or more products associated with the product data via communication with the one or more external manufacturer servers.

13. The system of claim 1, wherein the operations further comprise:
accessing contractor data from one or more external contractor servers,
wherein the collection of data corresponding to the prompt and dimensional information also includes the contractor data, wherein the first machine learning model generates the interior design plan for the physical space also based on the contractor data.

14. The system of claim 13, wherein the contractor data includes a specialty, an availability, and a geographic region of coverage for a contractor.

15. The system of claim 13, wherein the operations further comprise, in response to the user accepting the interior design plan, automatically initiate scheduling of a professional person for one or more services associated with the contractor data via communication with the one or more external contractor servers.

16. The system of claim 1, wherein the operations further comprise:
accessing contractor data from one or more external contractor servers; and
accessing product data from one or more external manufacturer servers,
wherein the collection of data corresponding to the prompt and dimensional information also includes the contractor data and the product data, wherein the first machine learning model generates the interior design plan for the physical space also based on the contractor data and product data.

17. The system of claim 16, wherein the interior design plan includes a list of tasks for the interior design plan and a timeline for each of the tasks based on availability indicated in the product data and the contractor data.

18. The system of claim 1, wherein the operations further comprise generating a 3D model that depicts an arrangement of architectural elements for the physical space based on the interior design plan.

19. The system of claim 18, wherein the operations further comprise displaying the 3D model in a Virtual Reality (VR) application, wherein the architectural elements and the physical space are digital representations.

20. The system of claim 18, wherein the operations further comprise displaying the 3D model in an Augmented Reality (AR) application, wherein a real-world camera feed of a user device is augmented by the 3D model to show the architectural elements overlaid on at least a portion of the real-world camera feed.

21. A method comprising:
identifying a prompt of a user indicating an intent of the user for a physical space;
receiving dimensional information regarding the physical space;
applying a collection of data corresponding to the prompt and dimensional information to a first machine learning model to generate an interior design plan for the physical space; and
causing display of a three-dimensional virtual space with virtual objects or patterns based on the interior design plan, wherein dimensions of the three-dimensional virtual space match the dimensional information of the physical space.

22. A non-transitory computer-readable storage medium storing instructions that, when executed by at least one processor, cause the at least one processor to perform operations comprising:
identifying a prompt of a user indicating an intent of the user for a physical space;
receiving dimensional information regarding the physical space;
applying a collection of data corresponding to the prompt and dimensional information to a first machine learning model to generate an interior design plan for the physical space; and
causing display of a three-dimensional virtual space with virtual objects or patterns based on the interior design plan, wherein dimensions of the three-dimensional virtual space match the dimensional information of the physical space.
